(19) United States
(12) Patent Application Publication
(10) Pub. No.: US 2014/0050831 A1
(43) Pub. Date: Feb. 20, 2014

(54) METHOD FOR PROLONGING THE SHELF LIFE OF AGRICULTURAL AND FOOD PRODUCTS

(71) Applicant: David Itzhak, Tel-Aviv (IL)

(72) Inventor: David Itzhak, Tel-Aviv (IL)

(73) Assignee: MEGAIR LTD., Rishon LeZion (IL)

(21) Appl. No.: 13/995,034

(22) PCT Filed: Dec. 15, 2011
(86) PCT No.: PCT/IL11/00948

§ 371 Date: Nov. 4, 2013

Related U.S. Application Data
(60) Provisional application No. 61/423,673, filed on Dec. 16, 2010.

(51) Int. Cl. A23B 7/152

(52) U.S. Cl. CPC A23B 7/152
USPC 426/419; 99/474

(57) ABSTRACT

The invention relates to a method for prolonging the shelf life of agricultural and food products placed in a large storage room having a volume greater than 200 m3, wherein said method comprises treating the air in said storage room by means of withdrawing air from the storage room, passing the air through a gas-liquid contactor, circulating an electrolyzed halide solution through said gas-liquid contactor, directing the treated air back into the storage room, wherein an acid is intermittently added to said circulated halide solution. An apparatus suitable for carrying out the method is also provided.

The quality of agricultural products tends to deteriorate quite rapidly after harvest. Specifically, microbial contamination in the air is one of the major causes responsible for shortening the postharvest life of fruit and vegetables. Consequently, there exists a need for protecting various food products, such as fresh fruit and vegetables, from microbial damage during storage and shipping. Temperature control, i.e., refrigeration, and preservative coatings are of course well accepted methods for lengthening the postharvest life of fruit and vegetables.

WO 2010/070639 describes a method for prolonging the shelf life of various agricultural products stored in a storage room. The method involves withdrawing air from the storage room, and causing the air to flow upward through a column in which a perforated, horizontal plate is mounted. A stream of an electrolyzed salt solution flows downwardly in the column. The two opposed streams of air and solution form a thick layer of bubbling liquid above the horizontal perforated plate. The treated air, i.e., the air that passed through the bubbling liquid, exits the column, and is directed back to the storage room. It has been found that in this way the air itself is transformed into a powerful disinfectant, having a favorable effect on the quality and shelf life of fruits and vegetables stored in the storage room. An apparatus suitable for carrying out the method set out above is also described in WO 2010/070639.

It has now been found that is possible to effectively prolong the shelf life of agricultural and food products placed in a large storage room (e.g., size of not less than 200 m³, preferably not less than 1200 m³), in particular a storage room loaded with few hundreds tons of fruits or vegetables, by means of intermittently generating an increased level of oxidants in the atmosphere of the storage room, e.g., a level of not less than 1 ppm of chlorine-containing oxidants. The increased oxidant level can be conveniently attained by withdrawing air from the storage room and passing the same through a gas-liquid contactor (in the form of the apparatus described in WO 2010/070639), where the air comes in contact with an electrolyzed salt solution, and intermittently adding an acid to the salt Solution undergoing electrolysis. The treated air which exits the gas-liquid contactor is returned to the storage room. The addition of the acid to the solution subjected to electrolysis results in enhanced formation of oxidants in the solution, and consequently also in the storage room, as indicated by a rapid increase in the level of oxidants, in particular chlorine-containing oxidants, measured in the storage room following the acid addition. The term ‘chlorine-containing oxidants’ particularly refers to chlorine and/or chlorine dioxide.

Accordingly, the present invention is primarily directed to a method for treating agricultural and food products placed in a large storage room having a volume greater than 200 m³, wherein said method comprises treating the air in said storage room by means of withdrawing air from the storage room, passing the air through a gas-liquid contactor, circulating an electrolyzed halide solution through said gas-liquid contactor, directing the treated air back into the storage room, wherein an acid is intermittently added to said circulated halide solution. One of the key advantages of this treatment procedure is the prolongation of the shelf life of the treated produce. In the context of the present invention, the term “shelf life” should be understood to include the entire storage period of the produce, from harvest to consumption. Preferably, the method disclosed therein is used to treat fruit and vegetables during the initial postharvest storage period.

The invention provides a method comprising:

placing produce in a large storage, room having a volume greater than 200 m³ (e.g., placing at least 10 tons of said produce); withdrawing air from said storage room; passing the withdrawn air through a gas-liquid contactor; circulating an electrolyzed halide solution through said gas-liquid contactor while intermittently adding an acid to the circulated halide solution; and directing the air which exits the gas-liquid contactor back into the storage room.

The term “storage room” is used herein to indicate any storage facility or container in which the fruit or vegetables are stored and/or packed, including during shipping, wherein the temperature in said storage room is preferably less than 45° C., more preferably less than 30° C. and even more preferably in the range between −1° C. and 14° C. (e.g., −1° C. and 12° C.) during at least a portion of the storage/packaging period, and preferably throughout the entire storage period. A non-limiting list of agricultural products, whose postharvest life can be lengthen according to the invention, includes fruit and vegetables such as grapes, strawberries, tomatoes, potatoes, sweet potatoes, onions, blueberries, peaches, mangoes, melons, eggplants, apples, apricots, cherries, avocadoes, peppers and citrus fruit, especially oranges, persimmon, pumpkins and squash (including fresh cut fruit and vegetables). By the term “food product” is also meant fresh meat, chicken and fish.

The invention provides a treatment regime which is suitable for large storage rooms and compatible with accepted local working practice. This treatment regime comprises a first mode of operation applied during the time the workers are present in the storage room, wherein air is withdrawn from the storage room, passed through the gas-liquid contactor and contacts with an electrolyzed chloride solution, thereby generating moderate, tolerable oxidant levels in the storage room during working hours (e.g., not more than 0.3 ppm free chlorine or 0.1 ppm chlorine dioxide), combined with a second mode of operation, applied at the time the workers are absent, e.g., at night time or during the weekend, etc., wherein air is withdrawn from the storage room, passed through the gas-liquid contactor and contacts with an electrolyzed chloride solution to which an acid was added. The acidification of the chloride solution undergoing electrolysis results in the rapid build-up of temporary peak levels of chlorine-containing oxidants in the storage room, which decay gradually, generally over a period of time of between half an hour and a few hours, depending on the size of the room, the load of agricultural products in the room, etc. Acceptable chlorine levels are then restored (e.g., between 0 and 0.3 ppm).

The halide salt solution used according to the invention is most preferably a chloride-containing solution (e.g., sodium chloride) having concentration of not less than 5% (w/w). Preferred chloride solutions include concentrated solutions of sodium chloride with a concentration of not less than 10 wt %, e.g., from 10 to 30 wt %, and also mixtures thereof with calcium chloride. The concentration of the calcium chloride in the solution is effective in reducing the rate of evaporation of water therefrom, and is preferably in the range between 20 and 200 g/liter.

The chloride solution is electrolyzed in an electrolytic cell. The term “electrolytic cell”, as used herein, refers to a set-up comprising electrodes connected to the opposite poles of a direct electrical current (DC) power supply. In its most simple configuration, an electrolytic cell suitable for use according to the present invention comprises two electrodes that are affixed within the reservoir used for storing the chloride solution, or alternatively, within a conduit in which the halide solution flows. The electrodes are preferably placed in parallel to each other, separated by a gap of 0.3 to 2.0 cm, and more preferably of 0.5 to 1.0 cm. The electrodes are preferably in the form of plates or meshes having a length and a width of about 2 and 10 cm, respectively. The electrodes are generally composed of a metal selected from the group consisting of Ti, Nb and Ta, coated with Pt, Ru, RuO₂ and Ir. Platinum, an alloy of platinum and iridium and electrodes of the type M-MO (wherein M designates a metal, and MO a metal oxide, such as Ir—TaO2) may also be used. The cell typically operates at a current density of 10³-10⁵ Ampere per square meter of anode, applying a voltage in the range between 2 and 12 V, and preferably about 3-5 V.

It should be noted that the electrolysis of the halide solution is carried out in a diaphragm-less cell, and the pH of the electrolyzed solution is normally alkaline. The acidification of the solution subjected to electrolysis is aimed at reducing the pH of the electrolyzed solution, but preferably without shifting the pH to the acidic range. The acid is preferably added in an amount sufficient to reduce the pH of the solution in one or more pH units, for example, from pH of 11 or more, to pH of about 7.5 to 9. Accordingly, the term “acidifying”, “acidification” and the like, as used herein, indicate the addition of an acid to the solution undergoing electrolysis, and not the formation of a solution with acidic pH.

The method of the invention preferably involves passing the stream of air, which is withdrawn from the storage room, in an upward direction through a gas-liquid contactor in the form of a column having a perforated surface horizontally mounted therein, and contacting said stream of air with the acidified, electrolyzed salt solution which is circulated through said column, to form a bubbling liquid above said perforated surface.

The vertically positioned column, which is described in more detail below, is divided by the horizontally aligned perforated surface into lower and upper sections. The electrolyzed solution is fed into the column in the upper section, flows downwardly through the column, collected in the lower section of the column below the perforated surface, and driven back to the upper section. A stream of air withdrawn from the storage room is caused to flow upward through the column. As a result, a bubbling liquid (i.e., a liquid through which a gas—air in the present case—is passed) is formed on the perforated surface placed within the column. Perforated surfaces for promoting the formation of a bubbling liquid are generally in the form of meshes or plates with a varying percent open area. The percent of the open area, in the form of perforation, should match the liquid and gas loadings into the column. The height of the bubbling liquid is preferably between 1 and 7 cm (the height depends on the geometrical parameters of the column and the open area of the perforated surface). The air preferably enters the column at a pressure of not less than 350 Pa, preferably not less than 450 Pa above the ambient atmospheric pressure (although suction mode may also be applied for forcing the air to flow into the gas-liquid contactor).

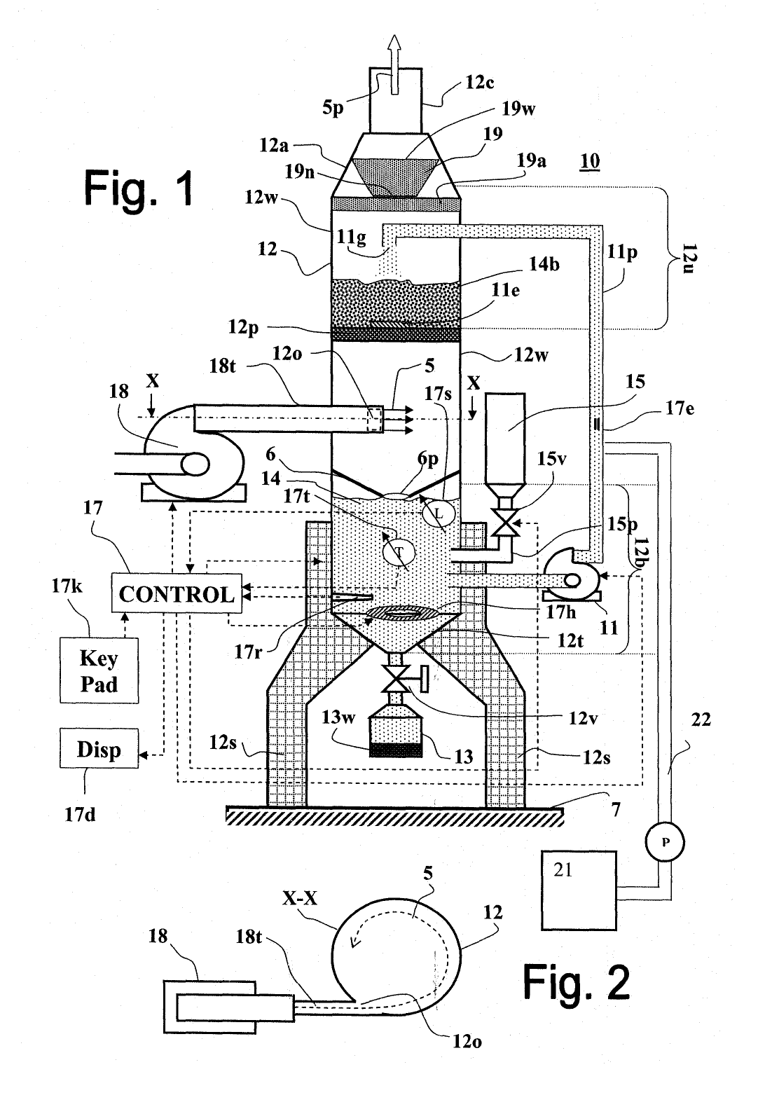

An apparatus comprising a gas-liquid contactor suitable for use according to the invention, which allows the circulation of an electrolyzed halide solution, the upward flow of an air stream and the formation of a bubbling liquid as described above, is preferably the apparatus described in WO 2010/070639, with some modifications permitting the intermittent injection of an acid into the circulated halide solution. The modified apparatus, which forms another aspect of the invention, is described below in detail in reference to FIG. 1.

In operation, the gas-liquid contactor (e.g., the apparatus illustrated in FIG. 1) is positioned outside the storage room, in proximity to its wall. A stream of air is withdrawn from the storage room and is caused to flow upwardly through the apparatus, using a blower with a throughput of about 100 to 3000 m³/hr, e.g., about 1000 m³/hr. During the operation of the apparatus, a volume of about 20 to 100 liters of chloride solution at a concentration of about 5 to 35% (w/w) is circulated in the apparatus and passed through a diaphragm-less electrolytic cell. The cell may be suitably located in the circulation line of the solution, namely, somewhere along the pipe conveying the solution from its reservoir. The electrolyzed solution which exits the electrolytic cell is caused to flow onto the perforated plate from above downwardly, while the air flows in the opposite direction, from below the perforated plate upwardly, and is contacted with the electrolyzed solution, such that the bubbling liquid is formed on the perforated plate. The outlet opening at the uppermost section of the apparatus is connected to the storage room through a suitable conduit, directing the recovered, treated air back to the storage room. The liquid is collected in the reservoir at the lower section of the apparatus, thus completing the circulation path of the solution.

According to the invention, an acid is intermittently added to the salt solution, e.g., once, twice or even more during night time, as required. The acid employed is preferably a mineral acid, especially an aqueous solution of hydrochloric acid at a concentration between 5 and 30% by weight. The acid is held in A suitable container (numeral 21 in FIG. 1) from which it is pumped at a suitable flow rate, e.g., from about 0.1 to 10 liters per hour using a metering pump mounted in the apparatus (indicated by the letter P in FIG. 1), and is added to the halide solution subjected to electrolysis. A suitable metering pump is the VCO model commercially available from EMEC, Italy. When the electrolytic cell (numeral 17e in FIG. 1) is positioned in the pipe lip used to transfer the halide solution from its reservoir to the perforated plate, then the acid is conveniently injected to the halide solution at a point located in that pipe 11p, between the pump 11 driving the salt solution from the bottom of the column and the electrolytic cell. The feeding time of the acid may last from 1 minute to one hour, e.g., from 1 minute to 30 minutes.

The concentration and the volume of the acid, its feeding rate and its feeding period may be adjusted in order to meet the target levels of the chlorine-containing oxidants in the storage room, while maintaining the pH of the electrolyzed solution slightly alkaline. For example, the treatment of 1000 m³ storage room in which a few hundreds tons of fruits are placed, may be accomplished through the injection of about 100 to 1000 cm³ of a concentrated hydrochloric acid (about 30% w/w) to the halide solution subjected to electrolysis during a period of about 10 to 30 minutes at night time, while passing the air of the storage room through the gas-liquid contactor in which the acidified electrolyzed solution is circulated, and allowing the re-circulation of the air to proceed essentially continuously for several hours. In this way, an increase in the level of chlorine-containing oxidants in the storage room is observed already a few minutes after the initiation of the acid addition and the passage of an acidified halide solution through the electrolytic cell.

As noted above, the period of addition of the acid into the electrolyzed solution is relatively short, e.g., less than an half an hour. The acidification procedure may be repeated once or twice and even more times during night time, if needed, for example, with fixed time intervals between the additions. It is understood, however, that the exact treatment regime should be compatible with accepted local working practice and the conditions in the storage facility (the volume of the room which is occupied by the agricultural products, kind of fruits/vegetables stored, bacterial load, etc.). For example, the fruits and/or vegetables placed in the storage room may be visually observed in order to determine whether the severe mode of treatment, involving the acidification of the electrolyzed solution, needs to be repeated on successive days.

The pH of the solution is preferably reduced by the addition of hydrochloric acid thereto, before said solution is passed through the electrolytic cell. The halogen-containing oxidants generated in the storage room include chlorine, chlorine dioxide or both, and their levels in the storage room can be measured using commercially available sensors, such as the gas detectors manufactured by BW technologies by Honeywell, Canada, under the names GasAlert extreme Cl₂ or GasAlert extreme ClO₂.

The method preferably comprises separating liquid droplets from the stream of treated air which exits the gas-liquid contactor, and directing the essentially droplet-free treated air back into the storage room, thereby providing one or more halogen-containing oxidants in the air of said storage room.

It should be noted that the acidification of the solution undergoing electrolysis allows the treatment of a large storage room having a volume in the order of a few hundred cubic meters, in which a few hundreds tons of agricultural products (e.g., not less than 100 tons) are loaded, using only a single apparatus of the type described in FIG. 1, or a small number of such apparatuses, and further permits the operation of said apparatus(es) under cost-effective amperage and voltage conditions. The addition of an acid, in particular aqueous hydrochloric acid, to the electrolyte allows its regeneration, such that it can serve for effective production of chlorine-containing oxidants in large spaces. Water and/or halide salt may be also added from time to time to the circulating salt solution, in order to compensate for water losses during operation.

The solution operative according to the present invention develops Redox (Reduction-Oxidation) potential of not less than 450 mV, and preferably between 500 and 1000 mV. The Redox potentials reported herein are measured using Pt/Ag/AgCl electrodes, thus indicating the electrochemical potential which is developed between Pt electrode exposed to the solution and a standard silver-silver chloride electrode.

In another aspect, the invention provides an apparatus comprising:

a) a gas-liquid contactor in the form of a vertically positioned column having an horizontally aligned perforated surface positioned therein, said perforated surface dividing said column into a first, lower section, which is provided with at least one air inlet opening, and a second, upper section, which is provided with at least one air outlet opening;

b) a reservoir for holding a halide salt solution, said reservoir being connected by means of a feed line into said second section at a point below said air outlet opening;

c) an electrolytic cell placed in said feed line;

d) a drop separator, which may be either physically integrated with said column, or provided as a separate unit;

e) means for forcing a stream of air to flow upwardly in said column;

wherein said apparatus is characterized in that it further comprises means for injecting an acid into said feed line, wherein said acid-injection means preferably comprises a tank for holding the acid, a conduit connecting said tank and the feed line, said conduit being connected to said feed line at a point below the point where the electrolytic cell is positioned in said feed line, and a metering pump for driving the acid from said tank along said conduit.

FIG. 1 schematically illustrates a gas-liquid contactor which is suitable for carrying out the method set out above. Apparatus 10 comprises a column 12 vertically leveled relative to ground surface 7 by means of lateral supports 12s, a perforated plate 12p mounted inside the column 12 in perpendicular to its walls 12w, a blower 18 communicating with the air inlet opening 12o formed in the wall 12w of column 12 below perforated plate 12p, and a pipe system lip adapted for piping fluids from the bottom portion 12b of column 12 to its upper portion 12u by means of pump 11 (e.g., magnetic rotary pump).

Column 12, which preferably has a cylindrical shape, is made of chemically resistant material such as, but not limited to, stainless alloys (such as austenitic, ferritic and martensitic stainless steels, titanium alloys, nickel-based super alloys and cobalt alloys) or suitable plastics (such as PVC, CPVC, polyethylene, polypropylene, polybutylene, PVDF, Teflon and polyester). The inner diameter of the column is generally in the range of 30 to 60 cm, preferably about 30-50 cm, its wall thickness may generally be in the range of 2 to 6 mm, preferably about 3 mm, and its height may range between 0.8 to 2 m, preferably about 1.2-1.5 m. The area of air inlet opening 12o is generally in the range of 100 to 400 cm². In a preferred embodiment of the invention, the opposite sides of the air inlet opening 12o are parallel to one another (e.g. the projection of the opening is rectangular), with a length in the range between 20 and 50 cm, and width in the range between 4 and 8 cm.

Perforated plate 12p is preferably made of a chemically resistant metallic or plastic material, such as those listed above. The thickness of the plate is preferably in the range of 1 to 5 mm. Perforated plate 12p is adapted to tightly fit in column 12 and occupy a cross-sectional area thereof, and is located above air inlet opening 12o. The pores in perforated plate 12p preferably occupy 30%-90% of its surface area.

Blower 18 is preferably an electric centrifugal blower capable of providing air streams in the range of 100 to 3000 m³/hr.

The bottom section 12b of column 12 serves for holding the salt solution 14. A treated air outlet 12c is provided in the upper space 12u of column 12. In operation, the salt solution 14 is continuously piped by fluid pump 11 and is delivered to the upper space 12u of column 12, while ambient air streams 5 introduced by blower 18 via air inlet opening 12o into column 12 are forced to pass perforated plate 12p and contact the salt solution, whereby an active layer of a bubbling liquid 14b is formed, following which a stream of treated air 5p exits column 12 via the air outlet opening 12c.

Partition member 6 is preferably mounted inside column 12 below air inlet opening 12o, wherein said partition member 6 has a funnel-like shape, downwardly tapering towards an opening 6p. Partition member 6 thus allows the salt solution falling from the upper space 12u to be conveniently directed to, and collected in, the lower space 12b of the column.

The outlet of blower 18 preferably communicates with air opening 12o of column 12 via a passage 18t (typically having a rectangular cross-section) adapted to fit over said opening such that the air streams passing therethrough are distributed through the area of air opening 12o. The diameter of the treated air outlet 12c may generally be in the range of 10 to 30 cm, its cross-sectional area preferably being essentially equal to the area of air opening 12o, such that the rate of flow of treated air stream 5p leaving column 12 via air outlet 12c is essentially equal to the rate of flow of ambient air stream introduced into column 12 via air inlet opening 12o (e.g., in the range of 100 to 2000 m³/hr). Alternatively, the diameter of purified air outlet 12c may be the same as the diameter of column 12.

Treated air outlet 12c is preferably connected to a tapering section 12a provided at the upper end of column 12. In order to minimize the escape of liquid drops through the air outlet opening, the drops may be separated from the treated air by passing the air through a suitable porous substrate or by providing a cyclone-type arrangement as well known in the art.

For example, one or more drops separating elements, may be installed in, or adjacent to, tapering section 12a. In one preferred embodiment a frustoconical member 19 made of porous material (e.g., a sponge), is mounted in tapering section 12a by means of supporting means (not shown), such that its small base 19n is facing perforated plate 12p and its large base 19w is facing purified air outlet 12c and occupies a cross-sectional area of tapering section 12a. In this way, the stream of treated air passing via tapering section 12a is forced to pass through conical member 19, thereby separating drops of the salt solution contained therein. Alternatively or additionally, a cross sectional section of column 12 may be also occupied by a piece of porous material 19a, preferably adjacent to tapering section 12a for further separating liquid drops from the treated air stream passing therethrough.

The drop separator may be provided as a separate unit, to be connected with the air outlet opening 12c. One possible arrangement is a cyclone separator (not shown), which was mentioned above. Another possible arrangement for a drop separator comprises a conduit (not shown) connected to the air outlet opening 12c, which conduit is downwardly directed, conducting the drops-containing treated, air into a suitable tank, where the drops can be collected. The solution thus recovered may be recycled, namely, delivered to the solution reservoir.

The apparatus 10 further comprises an electrolytic cell 17e, RedOx electrodes 17r and preferably. also level determining means 17s, temperature sensing means 17t, and a heating element 17h, all mounted in the bottom section 12b of the column 12, immersed in the salt solution 14, and electrically connected to a control unit 17. Control unit 17 is adapted for monitoring and managing the operation of apparatus 10 responsive to indicating signals received from RedOx electrodes 17r, level determining means 17s, and temperature sensing means 17t. Electrolytic cell 17e is employed for electrolyzing the salt solution passing between its electrodes during operation, preferably, responsive to RedOx readings obtained from RedOx electrodes 17r. Key pad 17k and display unit 17d (e.g., dot matrix or LCD) linked to control unit 17 may be respectively used by control unit 17 for receiving inputs from an operator, and for providing the operator output indications regarding the operation of system 10. Of course, apparatus 10 may comprise additional means connected to control unit 17 for generating output indications (e.g., leds, speakers). Control unit 17 may be implemented by a specially designed control logic circuitry, preferably by a programmable microcontroller. At least one analog to digital converter may be needed for control unit 17 for converting the signals received from RedOx electrode.

In the specific embodiment shown in FIG. 1, the electrolytic cell 17e comprises two electrodes that are affixed within the conduit 11p through which the salt solution is circulated. The electrodes are preferably placed in parallel to each other, separated by a gap of 0.3 to 2.0 cm, and more preferably of 0.5 to 1.0 cm. The electrodes are preferably in the form of plates or meshes having a length and a width of about 4 and 10 cm, respectively. The area of the electrodes may preferably vary in the range between 20 to 50 cm². The electrodes are electrically connected to the opposite poles of a direct electrical current (DC) power supply, which may be activated according to control signals received from control unit 17. The cell typically operates at a current density of 10³-10⁵ Ampere per square meter of anode, applying a voltage in the range between 2 and 12 V, and preferably about 3-5 V. The control unit and the electrodes power supply are preferably adapted to allow control unit to periodically alter the polarity of the electrodes in order to remove electrolytic deposits therefrom.

As mentioned above, a suitable set-up for measuring the Redox potential of the salt solution comprises a measuring electrode made of an inert metal or alloy (a platinum electrode) and a reference electrode (such as Ag/AgCl or calomel). Suitable electrodes are commercially available. The apparatus may further comprise a chlorine sensor (for example, CL2-B1 sensor).

As seen in FIG. 2, showing a cross-sectional view of system 10 taken along line X-X, blower 18 is attached to the air inlet opening 12o of column 12 such that the pressurized ambient air streams 5 introduced thereinto are directed more or less tangentially relative to the wall of column 12.

The bottom end section 12t of column 12 preferably tapers downwardly for draining precipitants formed in salt solution 14. A detachable waist disposal vessel 13 may be attached to the bottom end section 12t by means of a short pipe and valve 12v employed for blocking the passage therethrough whenever there is a need to detach waist disposal vessel 13 for removing waist precipitants 13w obtained thereinside. The pipe leading into waist disposal vessel 13 may comprise an optical sensor (e.g., photodiode—not shown) electrically connected to the control unit for providing indications regarding the turbidity of the solution in waist disposal vessel 13, thereby allowing the control unit to produce indications whenever the solution in waist disposal vessel 13 should be removed.

Pipe 11p communicating with the bottom section 12b of column 12, is preferably introduced into the upper space 12u of column 12, above perforated plate 12p, and its opening is preferably directed downwardly i.e., facing the upper face of perforated plate 12p. Perforated plate may include a relatively small plate 11e (e.g., a metallic disk of about 10 cm in diameter, made of suitable material, e.g., stainless steel) attached to its upper face below the opening of pipe 11g such that the solution streamed via pipe 11g encounters plate 11e, in order to prevent downward passage of the streamed solution through the pores of perforated plate 12p. It should be noted that the brine solution may be sprayed in the upper portion 12u of column 12 by means of sprinkles (not shown).

According to another preferred embodiment (not shown), the blower 18 is attached to the treated air outlet 12c and in this case it is adapted to apply suction for forcing a stream of ambient air into apparatus 10 through inlet opening 12o, and/or other suitable opening(s) (not shown) provided in apparatus 10.

Signals received by control unit 17 from level determining means 17s provide indications regarding the level of salt solution, and whenever it is determined that this level is not within an acceptable range, control unit 17 issues corresponding indications via display unit 17d (and/or vocal or visual indications, if such means are available). Alternatively or additionally, control unit 17 may halt the operation of system 10 whenever it is determined that the level of the solution is not within an acceptable range. Temperature sensing means 17t and heating element 17h are used by control unit 17 for monitoring and heating the solution 14.

Various aspects of operation of apparatus 10 may be managed by control unit 17 according to readings received from RedOx electrodes 17r, in particular, the monitoring and managing of the activity of halide salt solution 14 by means of electrolytic cell 17e, as discussed hereinabove.

Apparatus 10 may further optionally comprise a container 15, for holding a solution of oxidizer-scavenging compounds, wherein said container communicates with the bottom, portion 12b of column 12 through a pipe 15p. Valve 15v, which is provided on pipe 15p, may be used for controlling the feeding of the solution of the oxidizer-scavenging compounds into the solution, in order to reduce the Redox potential of the solution, if desired. Preferably, valve 15v is a controllable valve linked to control unit 17. In this way control unit 17 may be adapted to provide valve 15v control signals for altering its state and thereby controlling the passage of the solution of the oxidizer-scavenging compounds through pipe 15p into the bottom portion 12b of column 12, in order to decrease the Redox potential of the halide solution. Oxidizer-scavenging compounds which act as reducing agents, and specifically, sulfur-based reducing agents, such as water soluble salts of sulfite, bisulfite, thiosulfate, metabisulfite, hydrosulfite or mixtures thereof, as well as other reducing agents such as ascorbic acid are utilizable. The reducing agent may be kept in container 15 in a solid or in a liquid form (e.g., as an aqueous solution). For example, the aforementioned sulfur-based reducing agents are readily available in the form of aqueous solutions of their sodium salts, preferably with concentration varying in the range between 1 and 30% (w/w), more preferably about 5-10% (w/w). For example, when the volume of the chloride solution employed in the method of the present invention is between 10 and 20 liters, then a solution of sodium bisulfite, or sodium thiosulfate, having a concentration of about 5% (w/v) may be used in order to decrease the Redox potential of the chloride solution.

Blower 18 is preferably a type of controllable centrifugal blower (e.g., having PWA or voltage control) capable of receiving control signals from control unit 17 and adjusting its operation accordingly. Advantageously, control unit 17 may be adapted for producing control signals for altering the rates of air flow produced by the blower 18, responsive to readings received from the RedOx electrode 17r or chlorine/chlorine dioxide measurement devices coupled to the apparatus (not shown).

The acid-injection means incorporated in the apparatus includes a tank 21 for holding the acid, a conduit 22 connecting the tank 21 and the feed line 11p, and a metering pump (indicated by the letter P) for driving the acid from tank 21 along conduit 22. Conduit 22 is connected to the feed line 11p at a point below the position of the electrolytic cell 17e affixed within said feed line.

### EXAMPLES

### Example 1

Inhibition of Decay in Oranges Placed in a Large Storage Room

The apparatus shown in FIG. 1 was used for treating a large cooled storage room having a volume of approximately 1000 cubic meters.

In the room, which is kept at a temperature of about 5° C., were stored approximately 200 tons of oranges. The apparatus was placed outside the room; in proximity to the wall of the room. Air was withdrawn from the room and caused to flow through the apparatus using a blower with throughput of 1000 m³/hr. The treated air is directed from the apparatus back to the storage room through a conduit connecting the air outlet opening of the apparatus and an opening provided in the wall of the room, at height of about 2.5 meters. The electrolytic cell operated under the following parameters: current—15 Ampere, voltage—5 volt. The salt solution subjected to electrolysis was an aqueous solution of sodium chloride at a concentration of about 10% by weight. The volume of the sodium chloride solution placed in the reservoir of the apparatus was about 70 liter.

The apparatus was allowed to operate continuously under the conditions set out above for a period of one week, maintaining On the perforated surface located in the apparatus a layer of bubbling liquid, resulting from the counter streams of air and the continuously electrolyzed salt solution. Under routine mode of continuous electrolysis and recirculation of air and liquid through the apparatus, the levels of chlorine and chlorine dioxide measured in the storage room were about 0.1 ppm and 0.05 ppm, respectively. However, on each day of the test period, at about 21:00 PM, a volume of 300 cc of an aqueous solution of hydrochloric acid at a concentration of 30% by weight was gradually added over an interval of fifteen minutes to the salt solution using a metering pump. Following the addition of the acid, the level of chlorine and chlorine dioxide measured in the storage room were about 2.0 ppm and 1.0 ppm, respectively. About three hours later, these levels decrease to about 0.7 ppm and 0.3 ppm, respectively, and return to normal values of 0.1 ppm and 0.05 ppm, respectively, at morning time the day after, i.e., at approximately 6:00 AM.

The overall appearance of the oranges improved significantly following the treatment described above. It is believed that the method of the invention allows the treatment of the produce and the extension of their shelf life by killing spores on the produce, on the walls, shelves and other surfaces in the storage/packaging room during the initial postharvest storage period.

1) A method for treating agricultural and food products placed in a large storage room having a volume greater than 200 m³, wherein said method comprises treating the air in said storage room by means of withdrawing air from said storage room, passing the air through a gas-liquid contactor, circulating an electrolyzed halide solution through said gas-liquid contactor, directing the treated air back into said storage room, wherein an acid is intermittently added to said circulated halide solution.

2) A method according to claim 1, wherein the gas-liquid contactor comprises a vertically-positioned column having a horizontal perforated surface mounted therein, such that the air withdrawn from the storage room flows upward through said column and contacts with the electrolyzed acidified salt solution, forming a bubbling liquid above said perforated surface.

3) A method according to claim 1, further comprising separating liquid droplets from the stream of treated air and directing the essentially droplet-free treated air back into the storage room, providing one or more halogen-containing oxidants in the atmosphere of said storage room.

4) A method according to claim 1, wherein the halide salt solution undergoing electrolysis is a chloride-containing solution at a concentration of not less than 5% (w/w) , and the halogen-containing oxidants provided in the storage room include chlorine and/or chlorine dioxide.

5) A method according to claim 4, wherein the acid added is hydrochloric acid.

6) A method according to claim 5, wherein the hydrochloric acid is added into the chloride salt solution to provide a temporary level of chlorine-containing oxidants in the storage room of not less than 1 ppm.

7) A method according to claim 1, wherein the products placed in the storage room comprise fruit or vegetables.

8) A method according to claim 7, wherein the fruit and vegetables are selected from the group consisting of grapes, strawberries, tomatoes, potatoes, sweet potatoes, onions, blueberries, peaches, mangoes, melons, eggplants, apples, apricots, cherries, avocadoes, peppers, citrus fruit, persimmons, pumpkins and squashes.

9) A method according to claim 8, wherein the fruit includes oranges.

10) A method for treating agricultural and food products, the method comprising:
placing said products in a large storage room having a volume greater than 200 m³;
withdrawing air from said storage room;
passing the withdrawn air through a gas-liquid contactor;
circulating an electrolyzed halide solution through said gas- liquid contactor while intermittently adding an acid to the circulated halide solution; and
directing the air which exits the gas-liquid contactor back into the storage room.

11) An apparatus comprising:
a) a gas-liquid contactor in the form of a vertically positioned column having an horizontally aligned perforated surface positioned therein, said perforated surface dividing said column into a first, lower section, which is provided with at least one air inlet opening, and a second, upper section, which is provided with at least one air outlet opening;
b) a reservoir for holding a halide salt solution, said reservoir being connected by means of a feed line into said second section at a point below said air outlet opening;
c) an electrolytic cell placed in said feed line;
d) a drop separator, which may be either physically integrated with said column, or provided as a separate unit;
e) means for forcing a stream of air to flow upwardly in said column;
wherein said apparatus is characterized in that it further comprises means for injecting an acid nto said feed line.

12) An apparatus according to claim 11, wherein said acid-injection means comprises a tank for holding the acid, a conduit connecting said tank and the feed line, said conduit being connected to said feed line at a point below the point where the electrolytic cell is positioned in said feed line, and a metering pump for driving the acid from said tank along said conduit.
